(19) United States
(12) Patent Application Publication
(10) Pub. No.: US 2026/0201851 A1
(43) Pub. Date: Jul. 16, 2026

(54) AIRCRAFT PROPULSION ASSEMBLY

(71) Applicants: SAFRAN AIRCRAFT ENGINES, Paris (FR); GENERAL ELECTRIC COMPANY, SCHENECTADY, NY (US)

(72) Inventors: Raul MARTINEZ LUQUE, MOISSY-CRAMAYEL (FR); Michaël Franck Antoine SCHVALLINGER, MOISSY-CRAMAYEL (FR); Antoine Claude Baudouin Raoul Marie SECONDAT DE MONTESQUIEU, MOISSY-CRAMAYEL (FR); Laurent SOULAT, MOISSY-CRAMAYEL (FR)

(73) Assignees: SAFRAN AIRCRAFT ENGINES, Paris (FR); GENERAL ELECTRIC COMPANY, SCHENECTADY, NY (US)

(21) Appl. No.: 19/134,461

(22) PCT Filed: Dec. 5, 2022
(86) PCT No.: PCT/FR2022/052252

§ 371 Date: May 30, 2025

(51) Int. Cl. F02K 3/077; B64D 27/10; B64D 29/00; B64D 35/00; F02C 6/20

(52) U.S. Cl. CPC F02K 3/077; B64D 27/10; B64D 29/00; B64D 35/00; F02C 6/20

(57) ABSTRACT

An aircraft propulsion assembly having a nacelle surrounding a three-flow turbomachine including a gas generator, a fan that accelerates an air flow through the nacelle, an annular element between the generator and the nacelle defining a first duct and a second duct. The annular element can have a nose for splitting the flow into an air flow through the first duct and into an air flow through the second duct, the assembly can include a stator vane mounted between the nose and the fan, and a stator vane between the generator and the annular element, mounted between the nose and a rotor vane of a compressor of the generator, or between the annular element and the nacelle.

### TECHNICAL FIELD OF THE INVENTION

The present invention relates to the general aeronautic field. More specifically, it concerns an aircraft propulsion assembly comprising a triple-flow turbomachine and a nacelle. The invention also relates to an aircraft comprising such a propulsion assembly.

### TECHNICAL BACKGROUND

Conventionally, a propulsion assembly comprises a nacelle surrounding a turbomachine that generates the thrust required to propel an aircraft. To this end, the turbomachine successively comprises at least one compressor which compresses an air flow entering the nacelle, a combustion chamber in which the previously compressed air is mixed with fuel and then ignited to generate a flow of hot propellant gas, and at least one turbine which is set in rotation by this flow of hot gas, the turbine being connected by a shaft to the compressor. These elements form the engine, also called gas generator. The hot gas flow then escapes through a nozzle at the outlet of the turbomachine. A rotor vane, also known as a fan, is usually mounted upstream of the gas generator to accelerate the primary air flow.

There are also dual-flow turbomachines in which an annular splitter is mounted between the nacelle and the gas generator so as to split the flow entering the nacelle into a primary air flow flowing into the gas generator and a cold secondary air flow which circulates in the duct formed by the space between the nacelle and the splitter. The main advantage of these turbomachines is that they consume less fuel and are quieter.

The propulsion of certain aircrafts can also be ensured by triple-flow turbomachines, such as the one described in the application FR-A1-3 074 476, in which an unducted rotor vane forming a propeller is mounted upstream of the fan. This additional rotor vane is generally larger in span than the fan so that the upstream edge of the nacelle leads to the splitting of the flow accelerated by the unducted rotor vane into a main flow entering the nacelle and a tertiary air flow which flows around the nacelle. The main flow can then be split into primary flow and secondary flow as in a dual-flow turbomachine.

The use of the dual-flow and triple-flow turbomachines is characterized by their bypass ratio, which corresponds to the ratio of the mass of the secondary/tertiary flow to the mass of the primary flow. This bypass ratio can also vary according to the flight phases of the aircraft, in particular in the variable cycle turbomachines. Nevertheless, variations in the bypass ratio can lead to secondary/tertiary flow losses and therefore to a drop in efficiency and operability of the turbomachine.

### SUMMARY OF THE INVENTION

The purpose of the present invention is to overcome this drawback by proposing an architecture allowing both the straightening of the air flow entering the turbomachine and the minimization of the impact of the bypass ratio changes on the gas generator.

To this end, the invention relates to an aircraft propulsion assembly, this propulsion assembly comprising a triple-flow turbomachine and a nacelle which surrounds the turbomachine, said turbomachine comprising:
a gas generator comprising at least one compressor, one combustion chamber and one turbine, said gas generator being arranged along a longitudinal axis,
a first propeller mounted inside the nacelle and around the longitudinal axis and configured to accelerate an air inlet flow entering the nacelle,
at least one annular element arranged radially between the gas generator and the nacelle and defining a first internal annular duct for supplying the gas generator, and a second external annular duct with the nacelle, said annular element comprising upstream a first annular splitter nose which is configured to split said air inlet flow into a first air flow flowing in said first duct and into a second air flow flowing in said second external annular duct,
a second propeller mounted upstream of the nacelle and around the longitudinal axis and configured to accelerate a main air flow, said nacelle comprising upstream a second annular splitter nose which is configured to separate said main air flow into said inlet air flow flowing into the nacelle, and into a third air flow flowing around the nacelle. The propulsion assembly being characterized in that it further comprises:
a first stator vane extending radially between a casing of the gas generator and the nacelle, upstream of the first annular splitter nose and downstream of said first propeller, and
a second stator vane extending radially between a casing of the gas generator and the annular element, downstream of said first splitter nose and upstream of a first rotor vane of said at least one compressor of the gas generator, and/or between the annular element and the nacelle, downstream of said first annular splitter nose,
   and in that at least one of said first and second stator vanes is a variable pitch vane or comprises at least one variable pitch portion.

Thus, thanks to the invention, the straightening of the air flow entering the nacelle is performed upstream of the splitter so that the vanes present in the ducts only have the function of protecting the turbomachine from changes in the bypass ratio. Such an architecture allows to simplify the construction and the assembly of the various vanes present in limited spaces such as the ducts. The invention also allows greater freedom in the positioning of the variable pitch vane (which is entirely of variable pitch or comprises only a variable pitch portion and therefore another fixed part) depending on the space available for the means of actuating this pitch. For example, the space available is often very limited at the level of the first annular splitter nose (because the thickness available in this area is necessarily small), so it may be more attractive to place it in the nacelle.

The propulsion assembly may also have one or more of the following characteristics, taken alone or in combination with each other:
the first stator vane has variable pitch,
said second external annular duct is devoid of stator vane from said first annular splitter nose to a plane perpendicular to said longitudinal axis and passing substantially through a first stator vane of said at least one compressor of the gas generator,
in particular in the latter configuration, when the first stator vane is variable pitch, the second stator vane can be entirely fixed and not variable pitch; in this configuration, in fact, it is not necessary to have two consecutive variable pitch stator vanes,
   said second external annular duct comprises a third stator vane downstream of said first annular splitter nose,
in particular in the last configuration, when the first stator vane is variable pitch and the second stator vane is fully fixed, the third stator vane can comprise a variable pitch portion and a fixed part; also in this configuration, it is not necessary to have two consecutive variable pitch stator vanes,
   the third stator vane is located downstream of or in line with leading edges of the blades of said second stator vane, and upstream of or in line with leading edges of the blades of a first stator vane of said at least one compressor of the gas generator,
   the second stator vane extends radially between the annular element and the nacelle, and said first internal annular duct is devoid of stator vane upstream of a first rotor vane of said at least one compressor of the gas generator,
in particular in the latter configuration, the second stator vane is preferably of variable pitch,
   the second stator vane is located downstream of or in line with leading edges of the blades of said first rotor vane of said at least one compressor of the gas generator, and upstream of or in line with trailing edges of the blades of a first stator vane of said at least one compressor,
   the first stator vane and/or said second stator vane comprises blades, an upstream portion of which comprises a leading edge that is rotatable about a substantially radial axis, and a downstream portion of which comprises a trailing edge is fixed,
   the first stator vane and/or the second stator vane comprise blades, a downstream portion of which comprises a trailing edge that is rotatable about a substantially radial axis, and an upstream portion of which comprises a fixed leading edge, and first propeller and said first rotor vane are connected to a single shaft, and
said at least one first propeller and said first rotor vane are connected to a single shaft, preferably via a mechanical speed reduction gear.

The present invention also relates to an aircraft, in particular a transport airplane, comprising a propulsion assembly such as the one mentioned above.

### BRIEF DESCRIPTION OF THE FIGURES

Further characteristics and advantages of the invention will become apparent from the following detailed description, for the understanding of which reference is made to the attached drawings wherein:

FIG. 1 shows a schematic longitudinal section of a propulsion assembly comprising a dual-flow turbomachine;

FIG. 2 shows a double longitudinal schematic section of a civil type propulsion assembly comprising a dual-flow turbomachine;

FIG. 3 shows a schematic longitudinal section of a propulsion assembly comprising a triple-flow turbomachine;

FIG. 4 shows a double longitudinal schematic section of a civil type propulsion assembly comprising a triple-flow turbomachine;

FIG. 5 represents a double longitudinal schematic section of a propulsion assembly according to a first embodiment of the invention;

FIG. 6 shows a schematic double longitudinal section of a propulsion assembly according to a variant of this first embodiment of the invention;

FIG. 7 represents a double longitudinal schematic section of a propulsion assembly according to a second embodiment of the invention;

FIG. 8 represents a double longitudinal schematic section of a propulsion assembly according to a variant of the second embodiment of the invention; and

FIG. 9 represents a schematic radial section of a stator vane with variable pitch according to the second embodiment of the invention.

### DETAILED DESCRIPTION OF THE INVENTION

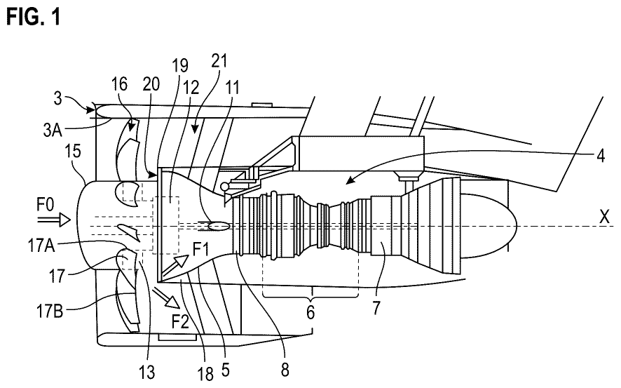

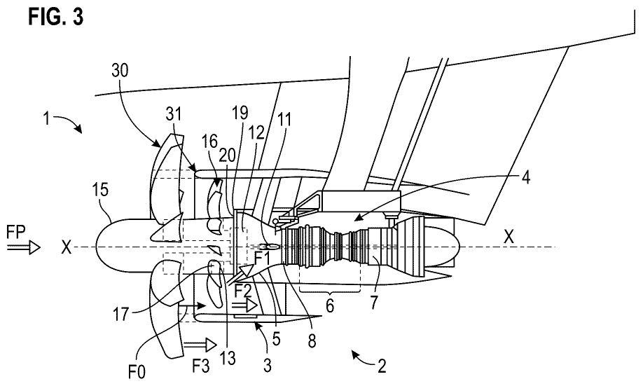

The propulsion assembly 1 for an aircraft (hereinafter “assembly 1”), whether civil or not, is shown schematically in FIGS. 1 to 8. The assembly 1 comprises a turbomachine 2 which is arranged along a longitudinal axis X-X. The turbomachine 2 is triple-flow in the context of a civil aircraft, for example, as shown in FIG. 3. Although not exclusively, the turbomachine 2 may be surrounded by a nacelle 3.

The turbomachine 2 conventionally comprises a gas generator 4 comprising at least one compressor 8, one combustion chamber and one turbine 7. As shown in FIGS. 1 and 3, the gas generator 4 forms a compartment 5 in which are preferably arranged a high-pressure body 6 formed by a high-pressure compressor, a high-pressure combustion chamber and a high-pressure turbine, not detailed in the figures, and a low-pressure body comprising at least one low-pressure turbine 7 arranged downstream of the high-pressure body 6 and a low-pressure compressor 8 arranged upstream of the high-pressure body 6. The high-pressure and low-pressure compressors 8 consist of an alternation of vanes of rotor 9 and stator 10 arranged successively from upstream to downstream around the longitudinal axis X-X. In the present invention, a rotor vane is defined as a wheel to which vanes or blades are attached and that rotates around the longitudinal axis X-X. A stator vane is also defined as a wheel to which vanes or blades are attached that do not rotate around the longitudinal axis X-X.

Furthermore, by convention, in the present application, the terms “upstream” and “downstream”, and “internal/under” and “external/over” are used in reference to a positioning with respect to an axis of flowing of the air flow along the longitudinal axis X-X of the turbomachine 2. Thus, a cylinder extending along the axis X-X comprises an internal face facing the axis X-X and an external face opposite its internal face. “Longitudinal” or “longitudinally” means any direction parallel to the axis X-X, and “radially” or “radial” means any direction perpendicular to the axis X-X.

The low-pressure turbine 7 drives a shaft 11. In a civil aircraft, a helical reduction gear 12, located upstream of the gas generator 4, transmits the torque exerted by the shaft 11 to at least one wheel 13. In the case of two wheels 13, they can rotate in opposite directions around the longitudinal axis X-X. The shaft 11 and the wheel(s) 13 are arranged in a casing or cover 15 which also houses the drive components for the wheel(s) from the reduction gear 12. Each of the wheels 13 carries vanes to define a propeller.

The triple-flow turbomachine 2 according to the invention comprises several propellers 16, 30. FIG. 1 shows a double-flow turbomachine 2 according to the prior art. This turbomachine 2 comprises a first rotor propeller 16 (hereinafter “propeller”) which is formed by a plurality of blades 17 distributed around the longitudinal axis X-X and extending in radial directions from the cover 15. As shown in FIG. 1, the propeller 16, also known as fan, is rotatably mounted within the nacelle 3 such that each of its blades 17 is attached to the wheel 13 through the cover 15 by a blade root 17A. Each of the blades 17 comprises a free radial end 17B which is opposite the root 17A and which faces an internal surface 3A of the nacelle 3. The incidence of each of the blades 17 varies from the root 17A to the free radial end 17B. In the present invention, “incidence” means the angle formed between the plane in which a blade and the longitudinal axis X-X are arranged. The rotation of the propeller 16 allows to accelerate an air inlet flow F0 entering the interior of the nacelle 3. Advantageously, the rotor vane 9 and the propeller 16 are connected together by a single body or shaft S which is shown in the drawings.

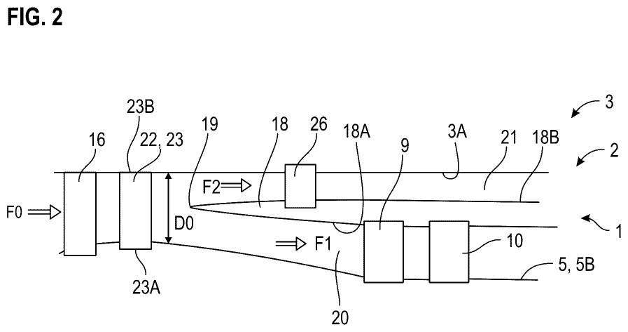

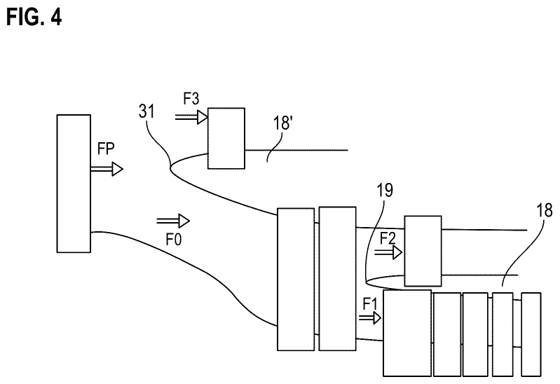

The turbomachine 2 also comprises one or more annular elements 18, 18′. As shown in FIG. 2 in particular, the annular element 18 is arranged radially between the gas generator 4 and the nacelle 3. As shown in FIG. 4, an annular element 18′is arranged upstream of a plurality of compressor stages. The annular element 18 extends along the longitudinal axis X-X for a length substantially similar to the length of the gas generator 4. The annular element 18 is provided upstream with an annular splitter nose 19. The arrangement of this annular element 18 with respect to the gas generator 4 defines a first internal annular duct 20 delimited by a casing 5B of the compartment 5 of the gas generator 4 and an internal surface 18A of the annular element 18. The arrangement of the annular element 18 with respect to the nacelle 3 also defines a second external annular duct 21 which is bounded by an external surface 18B of the annular element 18 and the internal surface 3A of the nacelle 3. The annular splitter nose 19 splits the air inlet flow F0 entering the nacelle 3 into a first air flow F1 which flows into the internal annular duct 20 and a second air flow F2 which flows into the external annular duct 21. The air flow F1 circulating in the internal annular duct 20 is classically compressed by stages of the low-pressure compressors 8 and high-pressure compressors formed by the succession of rotor vanes 9 and stator vanes 10 before entering the high-pressure combustion chamber. The combustion energy is recovered by the stages of high-pressure turbine and then low-pressure turbine 7 which drive the stages of compressor 8 and the upstream propeller 16. The air flow F2 which flows into the external annular duct 21 participates, for its part, in providing the thrust of the turbomachine 2.

The ratio of the air flow F2 flowing into the external duct 21 to the air flow F1 flowing into the internal duct 20 is generally called the bypass ratio. In a non-limiting manner, the propulsion assembly 1 according to the invention is variable cycle, i.e. the bypass ratio of the assembly 1 can be modified according to the phases of flight. As an example, the bypass ratio of the assembly 1 during a take-off or landing phase of the aircraft AC is high in order to reduce the noise and the specific fuel consumption.

In a first preferred embodiment, the assembly 1 further comprises a first stator vane 22 which is arranged upstream of the splitter nose 19 and downstream of the propeller 16. The blades 23 of the stator vane 22 are circumferentially distributed around the longitudinal axis X-X and extend radially over a whole distance DO between the gas generator 4 and the nacelle 3 so that each of the blades 22 is attached by a first internal end 23A to the cover 15 and by an external end 23B which is opposite to the internal end 23A to the internal surface 3A of the nacelle 3. Alternatively, the blades 23 could be fixed by only one of their radial ends, and could for example be suspended by being fixed by their radially external ends to the nacelle 3. As the blades 23 extend over the entire distance DO between the cover 15 and the nacelle 3, they do not influence the flow rate of the air inlet flow F0 entering the nacelle 3 and therefore the efficiency and the operability of the assembly 1. In addition, the presence of the stator vane 22 greatly reduces turbulence in the air inlet flow F0 upstream of the splitter nose 19, so that the incidence of the blades of the rotor 9 and stator 10 vane of the compressor 8 is not altered. The gas generator 4 is therefore not adversely affected by changes in the bypass ratio of the variable cycle assembly 1. In addition, the reduction in turbulence on the air inlet flow F0 allows a reduction in the aerodynamic losses of this flow F0 as well as of the air flow F1 and F2 circulating respectively in the internal veins 20 and external veins 21 on the edges of the annular element 18, the cover 15, the nacelle 3, etc. by reducing the friction surfaces.

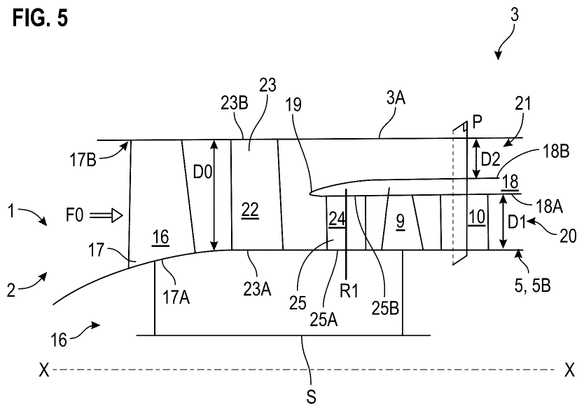

In this first embodiment, the stator vane 22 is fixed so that the incidence of each of the blades 23 does not vary, as shown in FIG. 5. In the scope of the present invention, the term fixed vane defines the set of blades mounted radially around the longitudinal axis X-X, each of the blades does not pivot around the radial axis along which it is arranged.

In this first preferred embodiment, the assembly 1 also comprises a second stator vane 24 which is of variable pitch. The blades of a variable pitch vane can rotate about a radial axis (or an axis slightly inclined to a radial axis) along which each blade extends. In practice, the blades can rotate around an axis that extends from the root to the tip of the blade. The casing is not necessarily straight, so depending on the position of the blade, the blade does not necessarily rotate around a perfectly radial axis. The introduction of variable pitch vane allows in particular to improve the operability of the turbomachine 2 for a range of flight conditions and to reduce its acoustic impact.

In FIG. 5, the propulsion assembly 1 further comprises another stator vane 22 downstream of the propeller 16, and a second propeller 30 upstream of this other stator vane 22 as shown in FIG. 3. The reference 30 refers to another propeller mounted upstream of the first propeller 16.

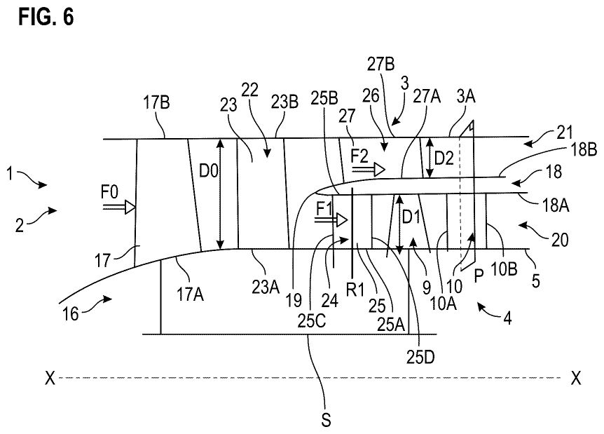

As shown in FIGS. 5 and 6, the stator vane 24 is arranged radially in the internal duct 20 in which the air flow F1 that supplies the gas generator 4 flows. The blades 25 of the vane 24 are distributed radially around the longitudinal axis X-X and extend over a distance D1 which corresponds to the distance between the casing 5A of the gas generator 4 and the annular element 18. Each of the blades 25 is fixed to the internal surface 18A of the annular element 18 by a radial end 25B and to the casing 5A of the gas generator 4 by a root 25A. Each of the blades 25 has an incidence allowing to straighten axially the air flow F1 entering the internal duct 20. As mentioned above, as an alternative, the blades 25 could be fixed by only one of their radial ends. Each of the blades 25 can pivot about a radial axis R1 (or slightly inclined to a radial axis) along which it is arranged. As shown in FIGS. 5 and 6, the stator vane 24 is arranged at the inlet of the internal duct 20, i.e. downstream of the splitter nose 19 and upstream of the first rotor vane 9 of the low-pressure compressor 8. For example, the variable stator vane 24 may be an Inlet Guide Vane (IGV) which has a low curvature and low loss compared with a conventional vane. The choice of a variable pitch guide vane allows to ensure the operability of the variable cycle assembly 1. On the one hand, the air flow F1 enters the internal duct 20 being for the most part straightened axially by the stator vane 22; it is therefore not necessary to have a conventional straightening vane at the inlet to the internal duct 20. On the other hand, the rotor vane 9 the most upstream of the low-pressure compressor 8 requires a certain level of co-turbulence, which therefore does not have to be eliminated by a conventional straightening vane at the inlet of the internal duct 20 of supplying of the gas generator 4. Since not all the turbulence has to be removed, the design of the stator vane 22 is also facilitated.

In this first particular embodiment, the external annular duct 21 is devoid of stator vane from the annular splitter nose 19 to a radial plane P as shown in FIG. 5. This radial plane P is perpendicular to the longitudinal axis X-X and passes substantially through the stator vane 10 furthest upstream of the low-pressure compressor 8 of the gas generator 4. The air flow F2 entering the external duct 21 does not encounter any vane during its flowing.

In a variant of this first particular embodiment, the external annular duct 21 comprises a third stator vane 26 mounted downstream of the annular splitter nose 19. The stator vane 26 is provided with a plurality of blades 27 arranged circumferentially around the longitudinal axis X-X and each extending in a radial direction over a distance D2 which corresponds to the distance splitting radially the annular element 18 and the nacelle 3. Each of the blades 27 is attached to the external surface 18B of the annular element 18 by a blade root 27A and to the internal surface 3A of the nacelle by a radially external end 27B. The presence of such a vane 26 allows to straighten the air flow F2 if the upper part of the air inlet flow F0, from which the air flow F2 comes, is more axially deflected than its lower part. In addition, each of the blades 27 of the vane 26 is preferably fixed and can be crossed internally by cables used in particular to supply electricity to the gas generator 4. By way of example the stator vane 26 is arranged downstream of, or in line with, the leading edges 25C of the blades of the stator vane 24 which do not form part of the low-pressure compressor 8 at least part of the stator vane 26 is also arranged upstream of, or in line with in line with the leading edges 10A of the blades of the stator vane 10 of the low-pressure compressor 8 of the gas generator 4 so that the vane 26 is close to the inlet of the external duct 21 to allow the air flow F2 to be straightened. More specifically, the leading edges of the blades of the vane 26 may be located downstream or at the level of (or at right angles to) the trailing edges 25D of the vane 24, and upstream or at the level of (or at right angles to) the leading edges 10A of the blades of the vane 10. The vane 26 may be of the OGV (Outer Guide Vane) type, for example.

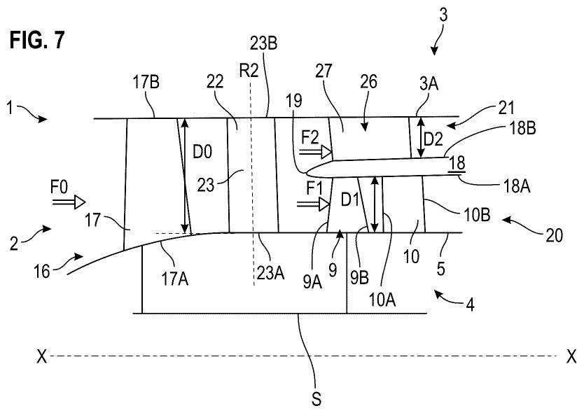

In a second embodiment of the invention shown in FIG. 7, the stator vane 22 has variable pitch so that the incidence of each of the blades 23 can be varied angularly. The variable pitch stator vane 22 comprises blades 23 capable of pivoting about the radial axis R2 (or slightly inclined with respect to a radial axis). The external annular duct 21 also comprises a stator vane 26, preferably fixed, mounted downstream of the annular splitter nose 19. The stator vane 26 is provided with a plurality of blades 27 arranged circumferentially around the longitudinal axis X-X and each extending in a radial direction over a distance D2 which corresponds to the distance splitting radially the annular element 18 and the nacelle 3. Only stages of the low-pressure compressor 8 comprising in particular the first rotor vane 9 followed by the first stator vane 10 are arranged in the internal duct 20. The first vane to encounter the air flow F1 after the stator vane 22 is therefore a rotor vane 9. This avoids introducing a variable pitch vane and the associated control mechanism into the element 18, which has very limited space, and instead moving this mechanism into the nacelle 3, which has more available space. A single control mechanism can therefore be used to influence two flow F1, F2.

The stator vane 26 can be arranged downstream or at the level of (or in line with) the trailing edges 9B of the blades of the rotor vane 9. More specifically, the trailing edges of the blades of the vane 26 may be located downstream or at the level of (or in line with) the trailing edges 9B of the vane 9. The stator vane 26 can be arranged upstream or at the level of (or in line with) the leading edges 10A of the blades of the stator vane 10 of the low-pressure compressor 8 of the gas generator 4 so that the vane 26 is located close to the inlet of the external duct 21 to enable the secondary flow F2 to be straightened.

In a variant of this second embodiment shown in FIG. 6, the turbomachine 2 also comprises the variable pitch stator vane 24. The stator vane 24 is arranged radially between the annular element 18 and the nacelle 3, inside the external duct 21 in which the air flow F2 flows. The vane 24 is mounted downstream of the annular splitter nose 19. The variable pitch stator vane 24 can be arranged upstream of the fixed stator vane 26 as described above. Alternatively, it may be the sole element of the external duct 21. The blades 25 are distributed radially around the longitudinal axis X-X and each is fixed, by its root 25A, to the external surface 18B of the annular element 18 and, by its external end 25B, to the inner surface 3A of the nacelle 3. Each of the blades 25 is arranged along a radial axis R3 (or slightly inclined with respect to a radial axis) about which it can pivot. Furthermore, in this second embodiment, the internal annular duct 20 is devoid of a stator vane arranged upstream of the rotor vane 9 of the low-pressure compressor 8. The absence of any particular vane upstream of the first rotor vane 9 and stator vane 10 of the compressor 8 allows the length of the gas generator 4 to be reduced. Each of the blades 25 of the vane 24 is then located downstream of the leading edges 9A of the blades of the rotor vane 9 of the compressor 8 in the internal duct 20 and upstream of the trailing edges 10B of the blades of the stator vane 10 of the compressor 8. Each of the blades 25 of the vane 24 may also be located in line with the leading edges 9A of the blades of the rotor vane 9 and upstream of the trailing edges 10B of the blades of the stator vane 10. The blades 25 may also be located downstream of the leading edges 9A of the blades of the rotor vane 9 and upstream of the trailing edges 10B of the blades of the stator vane 10. They may also be arranged downstream of the leading edges 9A of the blades of the rotor vane 9 of the compressor 8 in the internal duct 20, and in line with the trailing edges 10B of the blades of the stator vane 10.

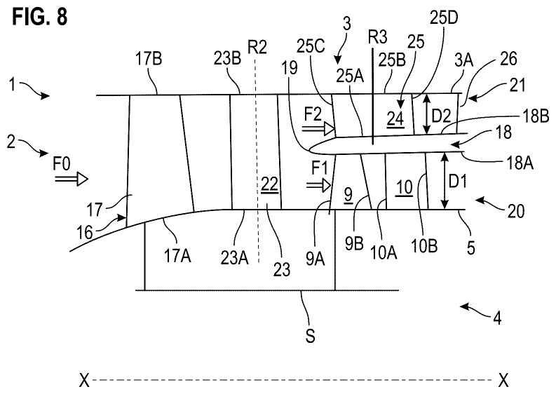

As shown in FIGS. 7 and 8, the vane 22 which is arranged between the propeller 16 and the annular splitter nose 19 has variable pitch. The impact of each of the blades 23 is adjusted so as to straighten the flow F0 flowing into the nacelle 3 before being separated into two flow F1 and F2. The axial straightening of the flow F0 by the variable pitch vane 22 allows the flow F1 in the internal duct 20 to flow opposite the leading edge 9A of each blade of the first rotor vane 9, which makes the presence of another straightening vane unnecessary at the inlet to the internal duct 20.

The installation of the variable pitch vane 24 in the external duct 21 has the advantage not only of axially straightening the flow F2 but also of eliminating the turbulence of the flow F0 which may be generated by the variations in incidence of the blades 23 of the vane 22.

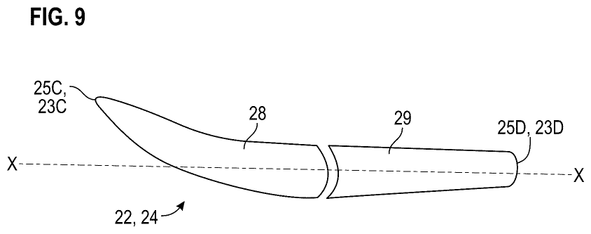

As shown in FIG. 9, this dynamic adjustment can also be achieved by blades 25 comprising a downstream portion 29 and an upstream portion 28. The downstream portion 29 may be, by way of example, a structural element that comprises the trailing edge 25D of the blade 25. This structural element is attached, by its ends (not shown), to the nacelle 3 and to the annular element 18. This upstream portion 28 may be hollow so that auxiliaries, such as cables, may pass through it in the radial direction for the supply of the gas generator 4. The upstream portion 28 is rotatable around a substantially radial axis common with the axis along which the downstream portion 29 extends. The upstream part 28 comprises the leading edge 25C of the blade 25, which can pivot as a function of the incidence of the vane 22 upstream so as to ensure axial straightening of the flow F2 flowing in the external duct 21. For this purpose, the vane 22 and the vane 24 are mechanically connected to each other (not shown). Alternatively, the changes in incidence of the blades 23 of the vane 22 are between 15 degrees and 20 degrees so that the vane 24 may be fixed. Such an arrangement offers the advantage of optimizing the integration of elements in the space available in the ducts, this space being all the more reduced as the annular element may require a defrosting device.

The vane 22 also comprises blades 22 provided with a downstream portion 29 comprising a trailing edge 23D and an upstream portion 28 comprising a leading edge 23C.

In a particular embodiment illustrated in FIG. 3, the assembly 1 comprises a triple-flow turbomachine 2. The assembly 1 then comprises a second rotor propeller 30 (hereinafter “propeller 30”). The propeller 30 comprises a plurality of blades extending radially around the longitudinal axis X-X in radial directions. This propeller 30 may be a rotor vane arranged upstream of a plurality of rotor and stator vane forming compressor stages in the turbomachine. The propeller is unducted. As shown in FIG. 3, the rotation of the propeller 30 generates an acceleration of a main air flow FP. The nacelle 3 also comprises, at an upstream end, a second annular splitter nose 31. This splitter nose 31 separates the main air flow FP accelerated by the propeller 30 into the air inlet flow F0 which flows into the space between the nacelle 3 and the cover 15 and which is accelerated by the rotation of the propeller 16 and into a third air flow F3 which flows above the nacelle 3.

In one variant, the propeller 30 is a rotor vane arranged upstream of a plurality of rotor and stator vanes forming the compressor stages present in the triple-flow turbomachine 2, as shown in FIG. 4.

Advantageously, the turbomachine 2 does not comprise an arm directly downstream of the stator vane 22. This means that the first flow splitter nose 19 is preferably not connected to arms and is not located downstream of the leading edges of such arms and upstream of the trailing edges of these arms. In general, such arms extend into the air flow F0 and into the air flow F1, F2.

1. An aircraft propulsion assembly, comprising:
a triple-flow turbomachine; and
a nacelle surrounding the turbomachine,
wherein the turbomachine comprises:
a gas generator comprising at least one compressor, one combustion chamber, and one turbine, the gas generator being arranged along a longitudinal axis;
a first propeller mounted inside the nacelle and around the longitudinal axis and configured to accelerate an air inlet flow entering the nacelle;
at least one annular element arranged radially between the gas generator and the nacelle and defining a first internal annular duct for supplying the gas generator, and a second external annular duct with the nacelle, the annular element comprising upstream a first annular splitter nose which is configured to split the air inlet flow into a first air flow flowing in the first duct and into a second air flow flowing in the second external annular duct;
a second propeller mounted upstream of the nacelle and around the longitudinal axis and configured to accelerate a main air flow, the nacelle comprising upstream a second annular splitter nose which is configured to separate the main air flow into the inlet air flow flowing into the nacelle and into a third air flow flowing around the nacelle;
a first stator vane extending radially between a casing of the gas generator and the nacelle upstream of the first annular splitter nose and downstream of the first propeller; and
a second stator vane extending radially between a casing of the gas generator and the annular element, downstream of the first splitter nose and upstream of a first rotor vane of the at least one compressor of the gas generator, and/or between the annular element and the nacelle, downstream of the first annular splitter nose,
wherein at least one of the first and second stator vanes is a variable pitch vane or comprises at least one variable pitch portion.

2. The propulsion assembly according to claim 1, wherein the second stator vane extends radially between the gas generator and the annular element, and the second external annular duct is devoid of stator vane from the first annular splitter nose to a plane perpendicular to the longitudinal axis and passing substantially through a first stator vane of the at least one compressor of the gas generator.

3. The propulsion assembly according to claim 1, wherein the second stator vane extends radially between the gas generator and the annular element, and the second external annular duct comprises a third stator vane downstream of the first annular splitter nose.

4. The propulsion assembly according to the preceding claim, wherein the third stator vane is located downstream of or in line with leading edges of the blades of the second stator vane, and upstream of or in line with leading edges of the blades of a first stator vane of the at least one compressor of the gas generator.

5. The propulsion assembly according to claim 1, wherein the second stator vane extends radially between the annular element and the nacelle, and the first internal annular duct is devoid of stator vane upstream of a first rotor vane of the at least one compressor of the gas generator.

6. The propulsion assembly according to claim 5, wherein the second stator vane is located downstream of or in line with leading edges of the blades of the first rotor vane of the at least one compressor of the gas generator, and upstream of or in line with trailing edges of the blades of a first stator vane of the at least one compressor.

7. The propulsion assembly according to claim 5, wherein the first stator vane and/or the second stator vane comprises blades, an upstream portion of which comprises a leading edge is rotatable about a substantially radial axis, and a downstream portion of which comprises a trailing edge is fixed.

8. The propulsion assembly according to claim 1, wherein the at least one first propeller and the first rotor vane are connected to a single shaft via a mechanical speed reduction gear.

9. An aircraft comprising at least one propulsion assembly according to claim 1.
